(19) United States
(12) Patent Application Publication
(10) Pub. No.: US 2017/0357092 A1
(43) Pub. Date: Dec. 14, 2017

(54) DISPLAY SYSTEM

(71) Applicant: The Technology Partnership Plc, Royston (GB)

(72) Inventors: Neil Griffin, Royston (GB); Roger Clarke, Royston (GB); Nick Wooder, Royston (GB)

(73) Assignee: The Technology Partnership Plc, Royston (GB)

(21) Appl. No.: 15/534,248

(22) PCT Filed: Dec. 8, 2015
(86) PCT No.: PCT/GB2015/053746

§ 371 Date: Jun. 8, 2017

(30) Foreign Application Priority Data
Dec. 9, 2014 (GB) 1421849.9

(51) Int. Cl. G02B 27/01; G02B 3/08; G02B 3/14; G02B 3/10

(52) U.S. Cl. CPC G02B 27/0172; G02B 3/10; G02B 3/08; G02B 3/14

(57) ABSTRACT

A display system is arranged to be placed in front of the eye or positioned in front of an image recording device that presents a view comprising the normal visual field overlaid with an image of a transparent display panel. The system comprises a transparent display panel positioned in front of the eye, and a dual focus lens positioned between the eye and the transparent display panel the lens arranged to allow the eye to focus on both the display panel and a view through the transparent panel.

The present invention relates to a display system and in particular a display system that is capable of being used on a head mounted display or a similar display which is intended for use close to the eyes of a user.

Head mounted displays (HMDs) are display systems that provide a view of a video screen that is visible to the wearer without the need to bring an external device in front of the face, freeing up the hands, and providing an always-present information view. Some HMD's are transparent, such that the video display image is superimposed over the normal view of the outside world. This has the benefit that the view of the world is not obscured by an opaque screen. This is especially helpful if the display is large or placed near the centre of the field of view. A transparent screen also has the benefit that it can be used for Augmented reality (AR) applications, where features on the display are designed to align with real-world objects, and provide added information about the view.

The key feature of any transparent HMD is a beam-combiner which superimposes the display image on the real world image. Existing solutions include prisms and Fresnel prisms, partially reflecting curved mirrors, volume holograms etc. Existing solutions suffer from disadvantages, including high cost, large size or restricted field of view [e.g. ref: Proc. SPIE Vol. 8720 0A-1].

Technologies also exist for virtual reality (VR) headsets, which are HMDs that provide a very wide field of view, but completely obscure the real world image, replacing it with the display image. One simple implementation of this (eg Oculus Rift) employs a short focal length lens placed close to the eye and a small (eg mobile phone-sized) screen. The lens creates a virtual image of the screen at a distance that the eye can comfortably view. The image has a very wide field of view of up to around 100°, creating an immersive experience. The limitations of this technology are that it cannot be used as a transparent display, the area outside the virtual screen is black and opaque, and the resolution is limited by the pixel size of the source display. Currently, the pixel size in the source displays used for VR headsets are relatively large so, when the display image is magnified up to the large field of view, the resulting angular resolution is much lower than for most conventional displays.

There is a need to improve head mounted display systems to combine the benefits of a transparent display with the large field of view achieved in VR headsets, while keeping the system lightweight and portable and being able to achieve high resolution.

According to the present invention there is provided a display system arranged to be placed in front of the eye or positioned in front of an image recording device that presents a view comprising the normal visual field overlaid with an image of a transparent display panel, where the system comprises a transparent display panel positioned in front of the eye, and a dual focus lens positioned between the eye and the transparent display panel, the lens arranged to allow the eye to focus on both the display panel and a view through the transparent panel.

The present invention combines elements of transparent HMDs and the VR headsets to create a new wide angle transparent HMD that can be readily adapted to have higher resolution than current VR headsets.

Examples of the present invention will now be described with reference to the accompanying drawings, in which:

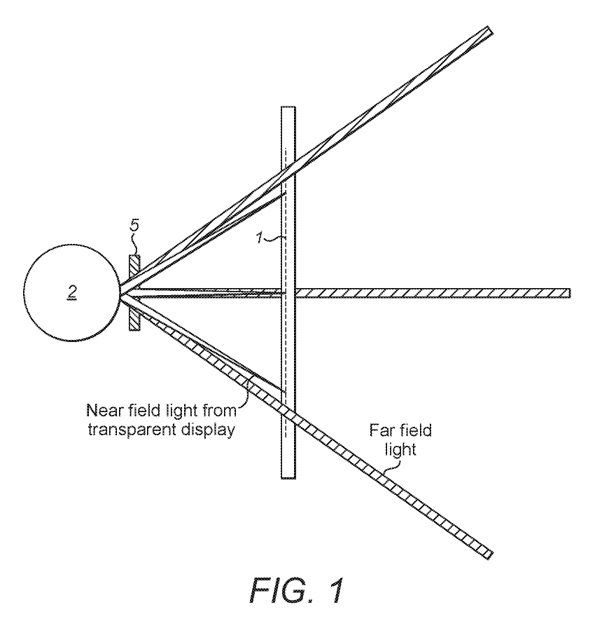

FIG. 1 is a schematic view of a device according to the invention, including light from the far field passing through the transparent display, and light from the transparent display focussed at infinity with the dual focus lens;

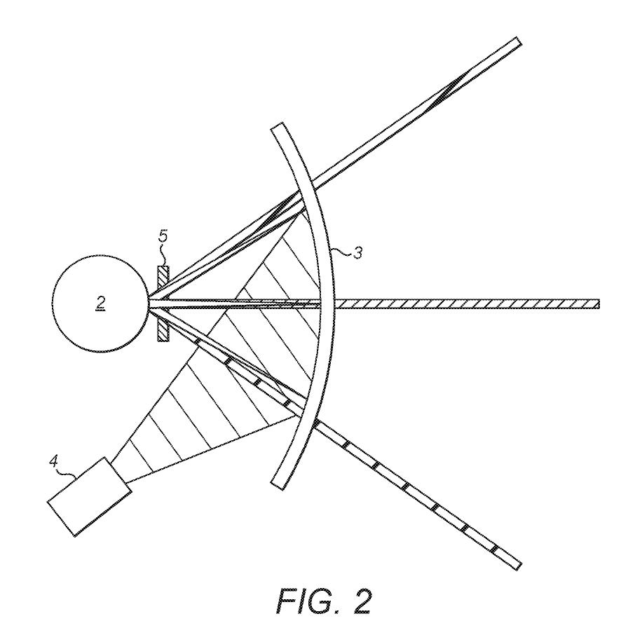

FIG. 2 shows an embodiment of the invention including a projector that projects an image onto the transparent viewing screen;

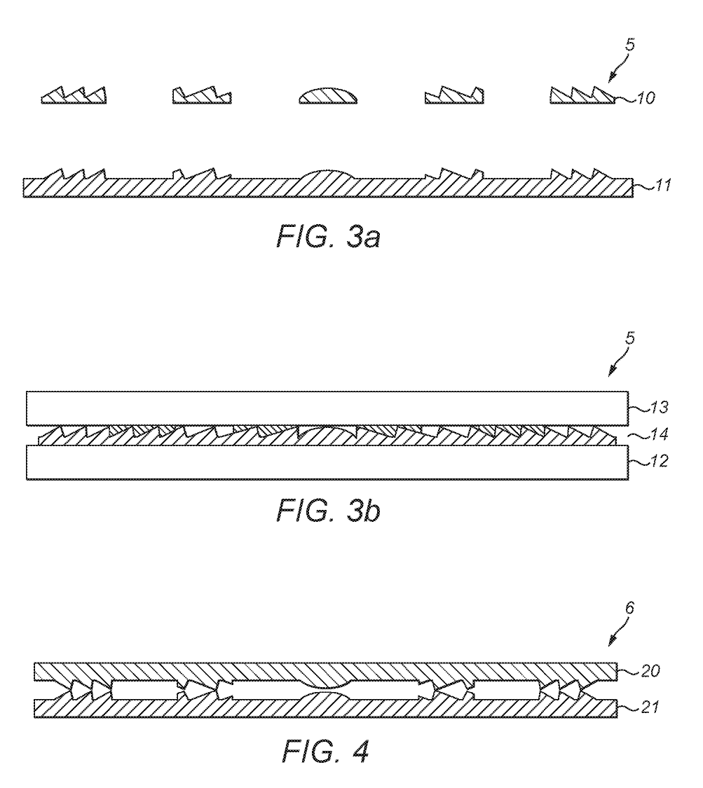

FIG. 3a shows a in a top part of the figure a cross section through a Fresnel lens where the long focal length zones are holes in the substrate and the bottom part of the figure shows a Fresnel lens with a backing substrate, so that the holes forming the long focal length zones are blind;

FIG. 3b shows an embodiment where the long focal length zones are formed by filling the gap between a Fresnel lens substrate and another substrate with index matching resin;

FIG. 4 shows an embodiment where two Fresnel lenses are used to improve the optical design, with minimal distance between the elements to reduce parallax errors; and

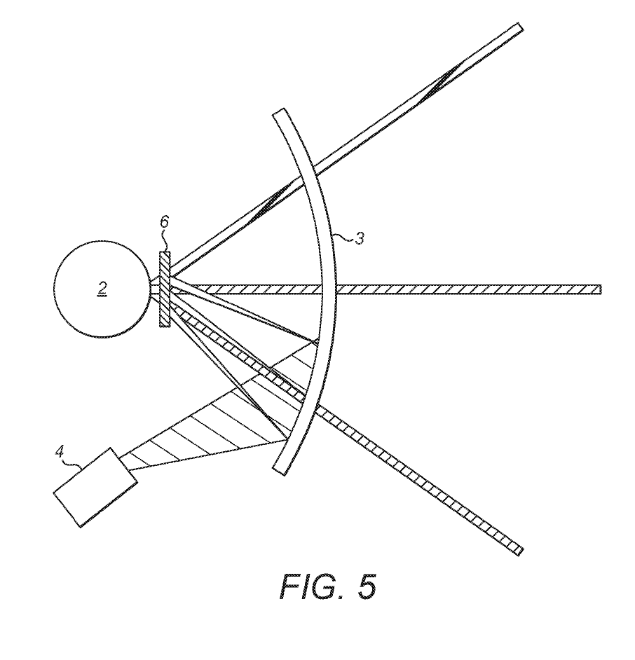

FIG. 5 shows an embodiment of a dual focus element showing focusing of a projected image that is substantially off-axis, allowing the straight through view to be unaffected by the projected image.

The optical arrangement of the present invention is depicted in FIG. 1. The basic approach follows that used by the VR headsets, but employs additional features to a) achieve a transparent display 1, and b) allow the eye 2 to simultaneously focus on the display and on the real world view.

The transparent display 1 can be achieved in multiple ways. Well known transparent displays 1 include LCD panels, and transparent OLED displays. Either of these can be used in place of the conventional opaque display used in a VR headset. In the case of the LCD panel, the device relies on back-illumination by ambient light, which can give a visible display image, but with very poor contrast. The illuminated display of an OLED is preferable because of the ability to produce high brightness/contrast images. Both of these approaches suffer the limitations that they are a) limited to a flat plane for conventionally fabricated devices (note that ‘flexible’ OLED screens are usually flat sheets that can bend, but cannot take up an arbitrary 3D curve).

An alternative approach is to project an image onto a transparent diffusing screen 3, such as that disclosed in PCT/GB2014/050680. This screen 3 can readily be formed into an arbitrary curved shape, and can use a standard video projector 4 as the source (this might preferably be a laser-based projector, as these are able to focus more easily onto a screen that is non-flat or at an oblique angle). Image manipulation is necessary to correct for distortion arising from the form of the diffuser surface and the incidence angle of the beam. FIG. 2 illustrates this arrangement. A laser projector 4 has the additional advantage that its pixel resolution is not fixed, and can provide a high density of pixels to give a high resolution image. Furthermore, this resolution can vary across the screen 3 so that the total scan speed and amount of projected data is minimised by having lower resolution at the periphery of the field of view.

The second modification to conventional VR optics is to provide a beam-combiner necessary for a transparent screen, while simultaneously providing for the ability to focus on both the screen image and the distant view within the comfortable accommodation range of the eye. This is achieved by replacing the simple short focal length lens with a lens 5 that has two different focal lengths, to provide focus on the two views. To provide a compact system and to make sure that the display image is significantly out of focus in the distant view, the short focal length should preferably be <100 mm. This dual focal length can be achieved either by sub-dividing the aperture into zones of different focal length, or by switching between two focal lengths using an appropriate technology, such as patent publication EP0693188, or by using a polarisation-dependent focal length. The beam combiner could also include other optical effects, such as tilt, to provide more flexibility in positioning of the display screen. By using tilt, the screen 3 could be positioned off-axis, potentially allowing the screen to be non-transparent.

To make the overlay of the real view and display image effective, a dual focus lens 5 is used, making a division of the aperture in space, time or polarisation which is imperceptible to the wearer. The long focal length lens should typically be chosen to provide zero optical power so that a person without the need for corrective vision can view the far field without a power change. For persons with the need for corrective vision, the optical prescription may be applied in the long focal length sub-divided aperture, or in the transparent display panel, or a combination of both. For spatial division the subdivided zones should be smaller than the pupil of the eye 2, so that light rays passing through both long and short focal length zones always reach the pupil irrespective of the exact pupil position and size. For time division, the switching rate should be faster than can be readily perceived by the eye for example greater than 96 Hz, and should furthermore be selected to avoid beating effects due to commonly used frequencies for light sources in the environment (eg fluorescent tubes, LED lights, LCD displays, etc).

Although this description is based on HMD's, similar optical systems could be applied in other areas, such as cameras, vision systems, binoculars, bifocal spectacles, etc, to provide superimposed images from multiple focal distances. It can also be applied to optical systems that work with non visible electromagnetic waves, including ultraviolet, infrared, terahertz, radio, or with non electromagnetic waves, such as acoustic waves.

Subdivision of the aperture of lens 5 using spatial or time-based multiplexing can also be extended to provide more than two optical paths.

There are a number of possible ways of providing the dual focus lens 5.

### A. Spatial Division—Zoned-Aperture Lens

For a typical system with the transparent display positioned a few tens of mm from the eye front surface, a bulk lens with the required focal length for a reasonably wide angle view will be relatively thick, of the order of several mm. To create long focal length zones within such a lens requires modification of an aligned segment of the front and back surfaces of the lens. Due to parallax, any small position change of the eye pupil will misalign these two surface segments, causing an unintended ray path for light through the lens. The effect of this is to superimpose additional unwanted light that is not focused on any intended location, adding haze to the overall view.

This problem can be greatly reduced by instead using a thin lens, such as a Fresnel lens or diffractive lens, which can be either flat, or formed as a thin layer on a curved surface. By minimising the overall thickness of the segmented optical component, the problem of rays crossing between the long and short focal length zones is minimised.

Examples of how this can be achieved with a Fresnel lens include:

1. Forming the Fresnel lens on a thin sheet 10, through which holes are cut (e.g. by laser drilling, mechanical drilling/cutting, melting with a hot pin or via other suitable mechanisms). The thin sheet 11 could be supported on a rigid transparent substrate for support. See FIG. 3a. Alternatively, the Fresnel lens can be moulded or cast from a mould that already has segments defined within it. This mould could be formed by diamond machining or another suitable method.

2. Forming the Fresnel lens on a rigid transparent substrate 12 (which may be flat, or may have a curved form to assist with optimisation of the overall optical design) and place a second rigid transparent window 13 over the top (again flat or curved), embedding the Fresnel surface in a thin gap between the two. The space 14 between the two rigid layer is then divided between regions that are filled with a transparent material that is index matched to the material of the Fresnel lens structure (ideally the same material; typically both might be a UV cured adhesive/resin), and regions that are not index matched (typically this would be an air gap, but could have an alternative non-matched transparent material. See FIG. 3b.

It may be preferable to have more than one zoned aperture lens to achieve good optical quality. In this case, to avoid the aforementioned parallax problems, the two thin lenses 20, 21 should be placed in close proximity and aligned precisely. For example, two zoned Fresnel lenses on substrates could be stacked with the Fresnel lenses facing inwards with a minimal gap as shown in FIG. 4.

The zoned-aperture lens 6 can either have no optical power in the long focal length zones, or it could have the option of an additional power covering all zones to correct for the visual prescription of the user. In addition to optical power, additional optical surfaces can also be used to improve image quality.

The pattern of lensing and non-lensing zones can be varied in a number of respects:
the geometry of the pattern
the scale of the pattern
the ratio of lensing to non-lensing area

The scale of the pattern should be small enough that the area of the lensing and non-lensing regions sampled by the eye pupil does not vary strongly with the precise position of the pupil. Conversely, it should not be so small that visual defects arising from diffraction effects are easily noticeable.

The geometry may be a regular pattern, such as stripes or dots, concentric circles (preferably aligned to the Fresnel zones of the lens) or a spiral, or a halftone screen pattern. Regular patterns are more likely to give rise to visual artifacts, so an irregular pattern, similar to a stochastic halftone screen pattern could be used. This has the effect of increasing the number of spatial frequencies passed by the aperture over a simple aperture design to improve the MTF of the system and therefore the apparent optical performance.

The ratio of lensing to non-lensing area is considered below, through discussion of the fraction of transmission through short and long focal length divisions of the lens.

### B. Time Division—A Switched Lens

A number of technologies exist that can provide switching of optical power. Technologies include the use of electrowetting (cf Varioptic), electroactive polymers (cf Optotune), analogue liquid crystal switching (cf Lensvector), two-state liquid crystal diffractive lens (cf Pixel Optics—WO94/23334) and mechanically adjusting lenses, such as the compact voice-coil based autofocus systems found in many compact cameras. Any of these approaches could be used, provided the required performance can be met as follows:—
the preferred separation of switching and display optics is <100 mm, so a power switching of >=10 dioptres is preferred.
switching speed fast enough to make the switching largely imperceptible (eg>96 Hz)
sufficiently large aperture to allow for the size, position and movement of the eye pupil (eg >6 mm lens diameter)
optical quality to give good images of both views, possibly in combination with additional optics

For many of the technologies mentioned, switching speed is a limiting factor. For improved imperceptibility of switching, especially for individuals who are more sensitive to light flicker, a frequency of >120 Hz is preferred. An alternative technology for achieving much higher frequency switching is to use a segmented lens, similar to the zoned described earlier, but in combination with a fast switched segmented aperture, where the aperture segments are aligned to the lens segments (cf WO2011/124986). The aperture can be formed for example from a ferroelectric liquid crystal device. The high frequency benefit is achieved at the cost of reduced overall transmission, since part of the aperture is obscured at any given moment.

### C. Polarisation Division—A Birefringent Lens

An additional approach to achieving a dual focus lens is to provide a lens that presents a different focal length to two polarisations of light. This could be achieved using a lens (possibly a Fresnel lens) made from a birefringent material so that the refractive index, and therefore the optical power is different for the two polarisations. To achieve a high optical power combined with zero, or close to zero optical power, it would be advantageous to combine the birefringent lens with a non-birefringent lens that provides optical power that cancels the optical power of one of the components of the birefringent refractive index. In one embodiment, the structured surface of a birefringent Fresnel lens would be planarised by coating with a clear resin with a refractive index that matches one of the birefringent refractive index components.

The ratio of transmission for the short and long focal length lens components is an important consideration. The preferred ratio is determined by the requirement to minimise the effect of unwanted features in the visual field, while still ensuring that both distant field and display image are visible. The short focal length view gives not only an image of the displayed image, but also defects near to that focal plane, and an out-of-focus view of the distant field. The long focal length view gives not only an image of the distant field, but also an out-of-focus view of the display image.

If the display is not self-illuminated (eg LCD), then, to obtain comparable contrast of both display and distant views, the transmission of short and long focal length views must be similar, thus it is difficult to suppress the unwanted features, described above (out-of-focus views, and images of display-plane defects). If the display is illuminated to be brighter than the background lighting, then transmission of the short focal length view can be reduced, while maintaining comparable brightness/contrast. This allows the visibility of un-illuminated features of the short focal length view to be decreased (ie defects near to display plane, and out-of-focus distant view). The disadvantage is that there is an increased visibility of the out-of-focus display image through the long focal length view, in the form of a background glare. This can be mitigated in a number of ways:
place the display plane as close to the eye as possible, to defocus the image as much as possible
keep the illuminated area of the display image small, through use of text/line-graphics etc, rather than using large illuminated areas. Since the brightness of the display is averaged over the defocused solid angle, this allows the glare brightness to be reduced without reducing the image brightness.
apply colour filters or polarising filters to the long focal length lens components. Then, by ensuring the display light is blocked by these filters (through use of narrow wavelength-band light, or polarised light), then the glare light can be suppressed without affecting light passing through the lensed zones. The narrow wavelength-band or polarised light can be generated either using a light source with this properties, such as a laser or lasers, or by including suitable filters in the illumination path.
for the time-switched approach, the illumination light can be switched off when the long focal length view is active, giving 100% suppression of the glare. If the far-field object is an appropriate switchable display then this can be switched in synchrony with the near field display illuminated light such that both near and far displays appear in focus simultaneously, without any defocused views of either display.

As will be appreciated from the above, the present invention, through the use of a novel and inventive combination of a display panel that is transparent in close alignment with a dual focus lens ensures that a lightweight display can be provided yet which has an appropriate level of resolution to provide good images to a user.

1. A display system arranged to be placed in front of the eye or positioned in front of an image recording device that presents a view comprising the normal visual field overlaid with an image of a transparent display panel, where the system comprises a transparent display panel positioned in front of the eye, and a dual focus lens positioned between the eye and the transparent display panel the lens arranged to allow the eye to focus on both the display panel and a view through the transparent panel.

2. The system of claim 1 wherein the view through the transparent panel is aligned with a secondary display positioned a distance further from the eye than the transparent panel.

3. The system of claim 1 where the dual focus lens comprises a spatially segmented lens, in which some segments place an image of the transparent display at a comfortable viewing distance, and other segments allow a direct view of the normal visual field.

4. The system of claim 3 where the spatially segmented lens is a spatially segmented Fresnel lens.

5. The system of claim 4 in which the Fresnel lens is embedded within the dual focus lens.

6. The system of claim 4 in which there are one or more segmented areas of the Fresnel lens which have no optical power.

7. The system of claim 3 in which there is an additional optical power in all zones to correct for any visual defects in the eye of a user.

8. The system of claim 3, in which the lensing and non-lensing zones are patterned so as to increase the number of spatial frequencies passed by the aperture over a simple aperture design to improve the MTF of the system and therefore the apparent optical performance.

9. The system of claim 1 where the dual focus lens comprises a lens that can switch between a higher optical power to place an image of the transparent display at a comfortable viewing distance and a lower optical power to allow a direct view of the normal view.

10. The system of claim 9 where the switching lens is a liquid crystal switching diffractive lens.

11. The system of claim 9 where the switching lens is a lens comprising segments of higher and lower power combined with a switching segmented aperture device that can alternately obscure the higher and lower power segments of said lens.

12. The system of claim 9 where the switching lens uses electrowetting or electroactive polymers to change the shape of an optical surface when an electrical current or voltage is applied.

13. The system of claim 1 in which separation of lens and display is <100 mm.

14. The system of claim 9 in which switching speed is >96 Hz.

15. The system of claim 1 in which the aperture of the dual focus lens is >6 mm.

16. The system of claim 1 where the dual focus lens comprises a lens that presents different optical powers to two polarisations of light so that it allows the transparent display to be viewed at a comfortable viewing distance and simultaneously allows a comfortable view of the normal visual field.

17. The system of claim 16 where the dual focus lens includes a birefringent lens

18. The system of claim 16 where the dual focus lens includes a birefringent Fresnel lens

19. The system of claim 17 where the birefringent lens is combined with a lens of optical power that is close to equal and opposite to the optical power of the birefringent lens as presented to one of the polarisation states.

20. The system of claim 1 where the transparent display panel and the intermediate optical component are substantially flat.

21. The system of claim 1 where the transparent display panel and the intermediate optical component are arbitrarily curved.

22. The system of claim 1 where the intermediate optical component enables an image displayed on the transparent display panel that is substantially off-axis to be viewed near on-axis so that the forward viewing direction through the transparent panel is substantially free of the image to be viewed.
